(19) United States
(12) Patent Application Publication
(10) Pub. No.: US 2025/0028859 A1
(43) Pub. Date: Jan. 23, 2025

(54) PROTECTING SENSITIVE DATA ASSOCIATED WITH TRAINING MACHINE LEARNING MODELS

(71) Applicant: NVIDIA Corporation, Santa Clara, CA (US)

(72) Inventor: Sean HUVER, Ridgefield, CT (US)

(21) Appl. No.: 18/353,586

(22) Filed: Jul. 17, 2023

(51) Int. Cl. G06F 21/62

(52) U.S. Cl. CPC G06F 21/6254

(57) ABSTRACT

Embodiments of the present disclosure relate to a method of performing one or more operations using a machine learning model. In some embodiments, the machine learning model may be trained, at least in part, using synthetic training data that may have been generated using one or more generative machine learning models. Further, the one or more generative machine learning models may be trained to generate the synthetic training data based at least on real training data designated for protection.

### BACKGROUND

Some machine learning systems-such as those corresponding to supervised learning models, unsupervised learning models, semi-supervised learning models, reinforcement learning models, deep learning models, and others—may be trained using one or more labeled datasets. For example, a dataset may include images of different facial expressions where the images are labeled identifying one or more characteristics included in a facial expression—e.g., smile, frown, lifted eyebrows, dimples, eyes open, eyes closed, etc. Continuing the example, a machine learning model may be trained using the labeled dataset such that, when introduced to new input data including one or more facial expressions, the trained or deployed machine learning model may be configured to identify one or more facial expressions and/or characteristics of facial expressions in the new input data.

Some machine learning models may be trained to analyze and/or recognize one or more characteristics included in sensitive data, which may include any data designated for protection (e.g., medical imaging data, biometric data, etc.). Some traditional approaches to training machine learning models to recognize characteristics included in sensitive data may include using one or more federated learning techniques to gain access to one or more training datasets including sensitive data. One limitation of using federated learning techniques is that the quality of the dataset cannot be determined until after the machine learning model has already been trained. Furthermore, the machine learning model may need to be moved between organizations, entities, users, and/or other systems that may include differing datasets including data and/or information designated for protection.

Further, other techniques for training machine learning models to recognize characteristics included in sensitive data may include one or more techniques designed to modify sensitive data such that the data is no longer designated for protection. As an example technique to modify real data, in the context of using personal, medical data to train one or more machine learning models, the medical data may be scrubbed of any personal information associated with the data (e.g., metadata, labels, etc.).

However, such approaches may be time consuming and costly to ensure the data is scrubbed sufficiently to overcome the designation for protection. Further, medical data, even when scrubbed, may include personal identifying information that may still lead back to the individual(s) and/or group(s) whose data is/are in the data due to the unique characteristics associated with any one individual's medical history. Additionally or alternatively, different countries, states, or governing bodies may have differing regulations regarding protected information (e.g., HIPAA requirements in the United States as opposed to GDPR regulations in the European Union). Therefore, sufficiently scrubbing and/or encrypting certain data in one jurisdiction may not be sufficient for another jurisdiction.

### SUMMARY

According to one or more embodiments of the present disclosure, synthetic training data may be aggregated. In particular, synthetic training data may have been generated using one or more generative machine learning models that may have been trained using real data designated for protection. In some embodiments, the real training data may be collected or measured in the real-world and the synthetic training data may be artificial in that the synthetic training data may be generated by the one or more generative machine learning models instead of being collected or measured in the real-world.

Additionally or alternatively, one or more analytical machine learning models may be trained using the aggregated synthetic training data. In particular, the one or more analytical machine learning models may be trained such that the one or more analytical machine learning models may be configured to analyze one or more characteristics corresponding to real input data that may include one or more characteristics included in the real training data.

The embodiments of the present disclosure may provide the benefits of using large datasets to train machine learning models that analyze sensitive data while also protecting sensitive data by using synthetic data for the training instead of sensitive data.

### BRIEF DESCRIPTION OF THE DRAWINGS

The present systems and methods for protecting sensitive data associated with training machine learning models are described in detail below with reference to the attached figures, wherein:

FIG. 1A illustrates an example environment for training a generative machine learning model using a sensitive dataset and generating a synthetic dataset using the generative machine learning model, in accordance with one or more embodiments of the present disclosure;

FIG. 1B illustrates an example environment for using the analytical machine learning model of FIG. 1A as trained to analyze and/or recognize one or more characteristics in real input data, in accordance with one or more embodiments of the present disclosure;

FIG. 2A illustrates an example environment for training a generative machine learning model using one or more sensitive datasets corresponding to one or more data sources and generating a synthetic dataset using the generative machine learning model, in accordance with one or more embodiments of the present disclosure;

FIG. 2B illustrates an example environment for training an analytical machine learning model based on the synthetic dataset of FIG. 2A, in accordance with one or more embodiments of the present disclosure;

FIG. 3 is a flow diagram showing a method for training an analytical machine learning model using synthetic data that is used as a substitute for sensitive data, in accordance with one or more embodiments of the present disclosure;

FIG. 4A is an illustration of an example autonomous vehicle, in accordance with one or more embodiments of the present disclosure;

FIG. 4B is an example of camera locations and fields of view for the example autonomous vehicle of FIG. 4A, in accordance with one or more embodiments of the present disclosure;

FIG. 4C is a block diagram of an example system architecture for the example autonomous vehicle of FIG. 4A, in accordance with one or more embodiments of the present disclosure;

FIG. 4D is a system diagram for communication between cloud-based server(s) and the example autonomous vehicle of FIG. 4A, in accordance with one or more embodiments of the present disclosure;

FIG. 5 is a block diagram of an example computing device suitable for use in implementing one or more embodiments of the present disclosure; and

FIG. 6 is a block diagram of an example data center suitable for use in implementing one or more embodiments of the present disclosure.

### DETAILED DESCRIPTION

One or more embodiments of the present disclosure may relate to generating synthetic data using a generative machine learning model, where the generative machine learning model may generate the synthetic data based on sensitive data. Further, in some embodiments, the synthetic data generated using the generative machine learning model may be used to train an analytical machine learning model to analyze one or more characteristics of real input data.

In these and other embodiments, reference to “synthetic data” may include data and/or annotated information that may be generated using one or more computer simulations, machine learning models, machine learning systems, etc. rather than data collected and/or measured in a real-world environment. In some instances, synthetic data may include one or more characteristics included in data collected, measured, and/or generated in a real-world environment referred to herein as “real-world data” or “real data.”

In some embodiments, the generative model may be trained to generate synthetic data using sensitive data. In these and other embodiments, the sensitive data may be labeled and/or otherwise characterized in such a way that the generative model may generate synthetic data including one or more of the same characteristics as the sensitive data; however, the synthetic data generated using the generative model may not be designated for protection. Additionally or alternatively, the generative model may generate synthetic data that may not be traceable back to the sensitive data used to generate the synthetic data.

In some embodiments, the generative model may be configured to generate one or more synthetic datasets based on one or more corresponding datasets including sensitive data, referred to herein as “sensitive datasets.” For example, the generative machine learning model may be trained using a first sensitive dataset to generate first synthetic data. Continuing the example, the generative model may additionally be trained using a second sensitive dataset to generate second synthetic data. Further, the first synthetic data and the second synthetic data may be combined to create a single synthetic dataset that may be used to train the analytical machine learning model.

In some embodiments, the term “analytical machine learning model” or “analytical model,” may refer to any suitable algorithms, computer systems, neural networks, deep learning models, and/or other models that may be configured to analyze one or more characteristics corresponding to input data. In some embodiments of the present disclosure, the analytical model may be configured to analyze one or more characteristics corresponding to real input data based on being trained using the one or more synthetic datasets.

Embodiments of the present disclosure may help improve analysis and/or recognition of one or more characteristics included in sensitive data using a machine learning model. Further, embodiments of the present disclosure may provide the benefits of using large datasets to train machine learning models that analyze sensitive data while also protecting sensitive data by using synthetic, non-sensitive data for the training while also avoiding limitations associated with other techniques such as federated learning techniques and/or data scrubbing.

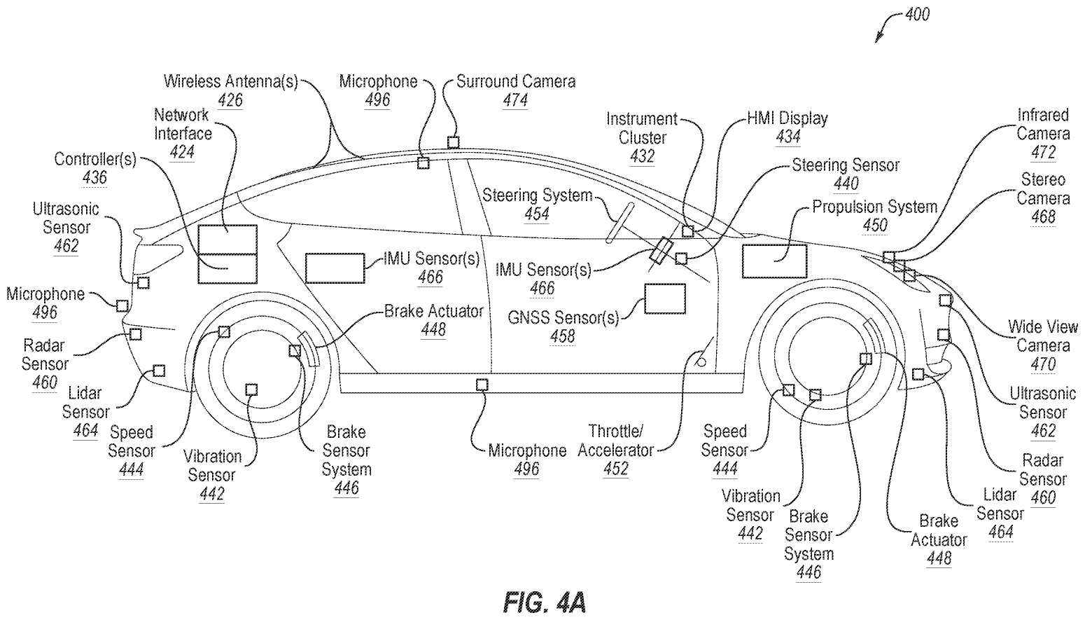

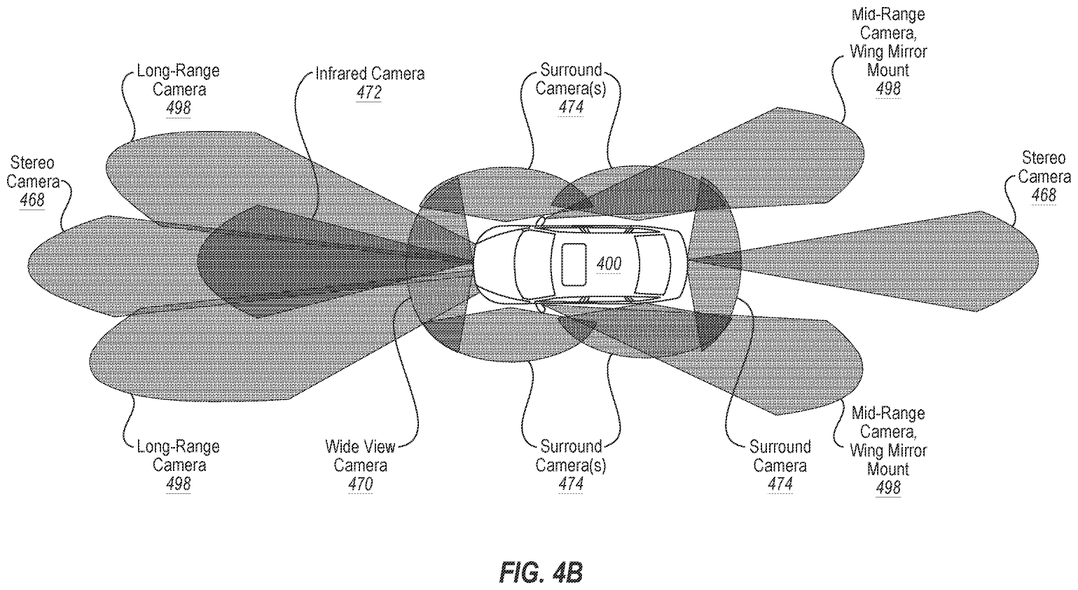

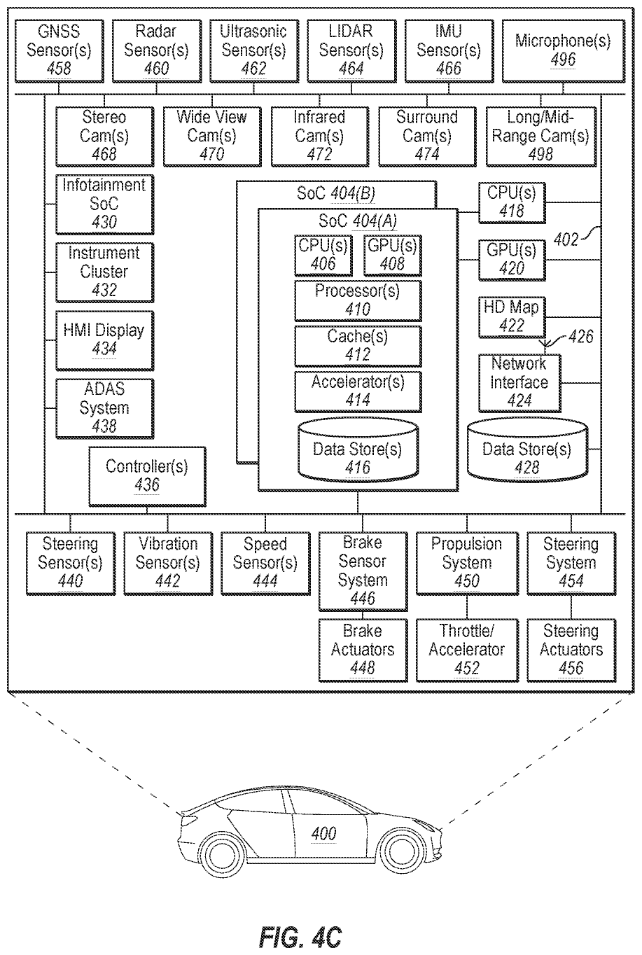

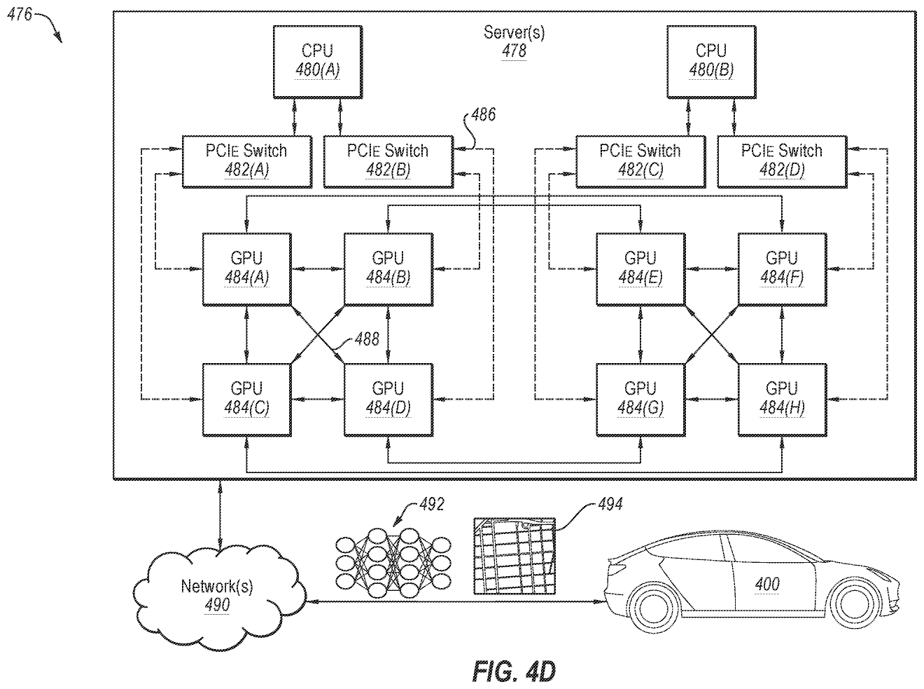

One or more of the embodiments disclosed herein may relate to generating synthetic data using a generative machine learning model trained using one or more sensitive datasets, and training one or more analytical machine learning models using the synthetic data. These trained analytic models may then be used in various applications, such as in any applicable machine or system for performing one or more autonomous or semi-autonomous operations, medical imaging operations, medical diagnostic operations, etc. Example autonomous or semi-autonomous machine (e.g., ego-machines) may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 400 (alternatively referred to herein as “vehicle 400” or “ego-machine 400) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

In some embodiments, one or more ego-machines may be configured to collect sensitive data and/or information. In some embodiments, the sensitive data may then be used to train a generative machine learning model that may generate synthetic data used to train one or more analytical machine learning models used in one or more ego-machines, autonomous vehicles, semi-autonomous vehicles, etc.

By way of example and not limitation, one or more ego-machines may include one or more sensors configured to generate data and/or information that may be used by insurance companies to determine insurance rates for individual drivers. Continuing the example, the data generated using one or more sensors may include personal information corresponding to one or more individual drivers of the ego-machine—e.g., location data corresponding to the location of the ego-machine including home addresses, work addresses, route habits, data and/or information that may incriminate the one or more individual drivers (speeding data, reckless driving etc.).

Continuing the example, the data and/or information collected for insurance companies may be designated for protection and therefore considered sensitive data. The sensitive data may then be used to train one or more generative machine learning models to generate synthetic data that may include one or more characteristics included in the sensitive data without being designated for protection. The synthetic data may then be used to train one or more analytical machine learning models that may be included in one or more ego-machines (e.g., autonomous, or semi-autonomous vehicles). The analytical machine learning models included in the ego-machines may be trained to recognize and/or analyze real input data (e.g., sensor data). Further, because the synthetic data may not be sensitive or otherwise designated for protection, the synthetic data may be used to train the one or more analytical machine learning models to improve, for example, one or more analytical machine learning models used by the ego machine.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

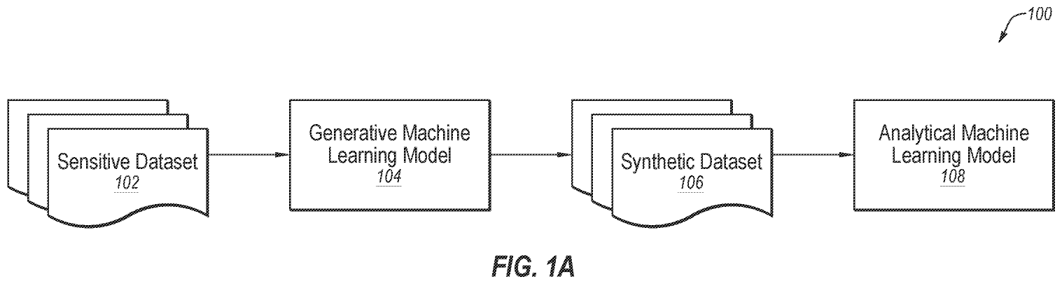

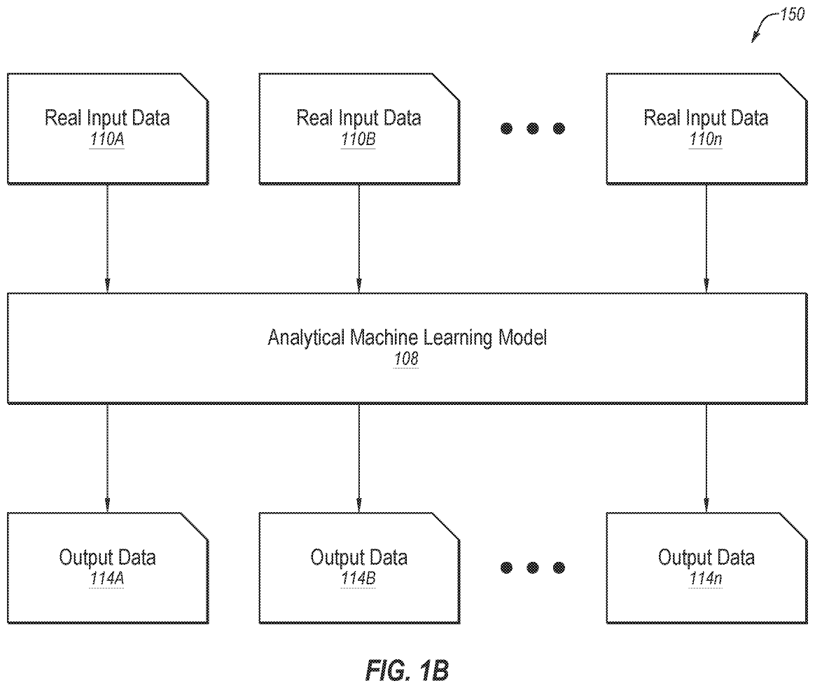

With respect to FIG. 1A, FIG. 1A illustrates an example environment 100 for training a generative machine learning model 104 using a sensitive dataset 102 and generating a synthetic dataset 106 using the generative machine learning model 104, in accordance with one or more embodiments of the present disclosure.

The sensitive dataset 102 may include real data—e.g., data collected, measured, and/or generated in a real-world environment in contrast to synthetic data that may not be collected and/or measured in a real-world environment. In some embodiments, the sensitive dataset 102 may include real data annotated using one or more labels describing one or more characteristics of the real data.

In some embodiments, the sensitive dataset 102 may include real data and/or annotated information that may be sensitive, protected, and/or otherwise designated for protection, which is referred to generally herein as “sensitive data.” For example, sensitive data may include medical images (e.g., data generating using computed tomography (CT) scans, magnetic resonance imaging (MRI), ultrasound, positron emission tomography (PET), mammography, thermography, and other medical imaging systems), diagnostic results, medical notes, and other data and/or information designated for protection. Other examples of sensitive data may include company secrets, intellectual property, sensor data, video streams, client-specific data, and other sensitive information that may be designated for protection from disclosure, substitution, and/or compromise.

In some embodiments, sensitive data and/or information designated for protection may include data designated for protection by a regulatory agency. For example, data including one or more specific characteristics (e.g., personal medical information) may be regulated by the health insurance portability and accountability act (HIPAA) in the United States, the general data protection regulation (GDPR) in the European Union, and/or other regulations or regulatory agencies. Continuing the example, any data regulated by HIPAA and/or GDPR may be considered sensitive data or data that may be designated for protection—e.g., data included in the sensitive dataset 102.

In some embodiments, the sensitive dataset 102 may include data that may be arbitrarily designated for protection by the party, system, entity, etc. that may own, use, or otherwise control data corresponding to the sensitive dataset 102. For example, an entity may control and/or own data that the entity may consider to be part of their intellectual property. Continuing the example, regardless of whether the data controlled by the entity may, in actuality, be part of the entity's intellectual property, the data may be included in the sensitive dataset 102.

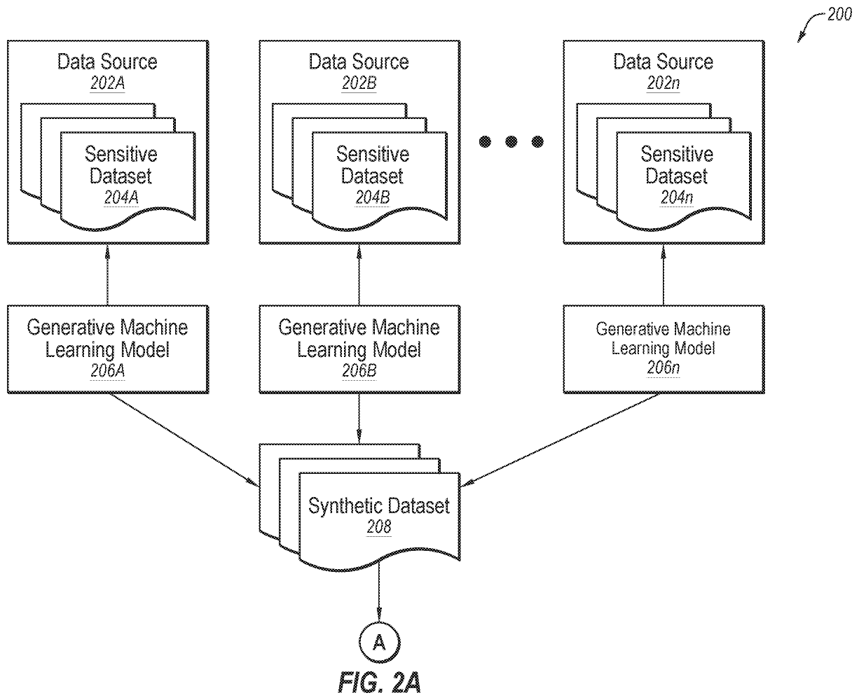

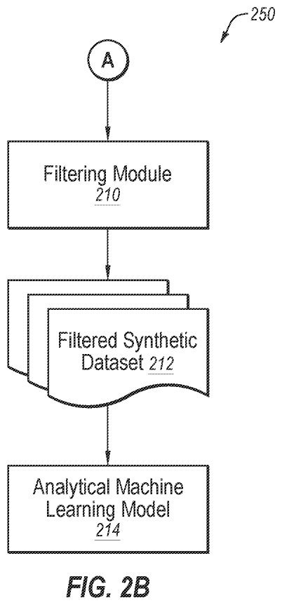

In some embodiments, the sensitive dataset 102 may include sensitive data that may have originated in one or more different locations and/or data owned and/or controlled by one or more entities. For example, a first entity may control a first amount of medical imaging data and a second entity may control a second amount of medical imaging data. Continuing the example, the first amount of medical imaging data and the second amount of medical imaging data may be included in the sensitive dataset 102. In some embodiments, the sensitive dataset 102 including data owned and/or controlled by one or more entities may be further described and/or illustrated in the present disclosure, such as, for example with respect to FIG. 2A.

In some embodiments, the sensitive dataset 102 may include data and/or information that may include one or more overlapping characteristics such that the sensitive dataset 102 may be used to train one or more generative machine learning models 104. For example, the sensitive dataset 102 may include sensitive data and/or information corresponding to medical notes generated for one or more patients. Continuing the example, the data and/or information corresponding to the one or more patients may include one or more similar characteristics (e.g., diagnostic information, weight, height, dietary restrictions, etc.) such that the data may be used in the sensitive dataset 102 to train one or more machine learning models (e.g., the generative machine learning model 104).

The generative machine learning model 104 may include one or more machine learning models that may be trained using the sensitive dataset 102 to generate synthetic data that may be included in the synthetic dataset 106. In these and other embodiments, the generative machine learning model 104 may include any suitable algorithms, computer models, neural networks, deep learning models, or other systems and/or models that may be trained to generate synthetic data (e.g., synthetic data that may be included in the synthetic dataset 106). In some embodiments, the generative machine learning model 104 may be trained by learning one or more distributions associated with the sensitive data 102 (e.g., real training data) such that one or more second distributions associated with the synthetic dataset 106 are within a threshold similarity to the one or more first distributions.

Additionally or alternatively, the generative machine learning model 104 may be configured and/or trained to augment the sensitive data included in the sensitive dataset 102. In some embodiments, augmenting the sensitive data may include adding, taking away, and/or modifying one or more features, characteristics, qualities, traits, attributes, data, metadata, etc. that may have been included in the sensitive data. In some embodiments, the generative machine learning model 104 may be trained using the sensitive data in the sensitive dataset 102 to generate synthetic data and/or augment the sensitive data to generate synthetic and/or augmented data included in the synthetic dataset 106.

By way of example and not limitation, the generative machine learning model 104 may include a generative adversarial network (GAN), generative stochastic networks (GSN), generative moment matching networks (GMMN), deep convolutional adversarial networks (DCGAN), Wasserstein GAN (WGAN), diffusion machine learning models, transformer machine learning models, and/or other machine learning models that may be configured to generate synthetic data.

In some embodiments, the generative machine learning model 104 may be trained to generate synthetic data included in the synthetic dataset 106 where the synthetic data may not be sensitive or otherwise designated for protection. In these and other embodiments, the sensitive data may be labeled and/or otherwise characterized in such a way that the generative machine learning model 104 may generate synthetic data including one or more of the same characteristics as the sensitive data. However, the synthetic data generated using the generative machine learning model 104 may not be designated for protection. Additionally or alternatively, the generative machine learning model 104 may generate synthetic data that may not be traceable back to one or more individuals corresponding to data in the sensitive dataset 102 and/or any characteristics or features of the sensitive data that may have made the sensitive data designated for protection.

For example, the sensitive data may include medical images that may be designated for protection, in part, because of the personal identifiers corresponding to the medical images. Continuing the example, the generative machine learning model 104 may generate synthetic data based on an amalgamation of the medical images such that the synthetic data is not the same as any of the different medical images. In this example, the synthetic data may include one or more characteristics included in the different medical images; however, the synthetic data may not be traceable back to the medical images as a dataset, any one of the medical images included in the dataset, and/or any of the individuals associated with the medical images of the sensitive dataset 102. Further continuing the example, the synthetic data may not be designated for protection because the synthetic data may not include any of the characteristics included in the medical images that may have designated the medical images for protection (e.g., personal identifying information).

In some embodiments, the generative machine learning model 104 may be configured to generate one or more synthetic datasets 106 based at least on one or more corresponding sensitive datasets 102. For example, the generative machine learning model 104 may be trained using a first sensitive dataset to generate first synthetic data. Continuing the example, the generative machine learning model 104 may additionally be trained using a second sensitive dataset to generate second synthetic data. Further, the first synthetic data and the second synthetic data may be combined to create a single synthetic dataset 106.

The synthetic dataset 106 may include data and/or annotated information that may be generated using one or more computer simulations, machine learning models, machine learning systems, etc. rather than data collected and/or measured in a real-world environment. In some instances, synthetic data may include one or more characteristics included in data collected, measured, and/or generated in a real-world environment. In some embodiments, the synthetic data that may be included in the synthetic dataset 106 may include one or more characteristics included in data included in the sensitive dataset 102. In some embodiments, the synthetic data included in the synthetic dataset 106 may include all, or substantially all, of the characteristics included in data included in the sensitive dataset 102.

In some embodiments, the synthetic data included in the synthetic dataset 106 may be used to train one or more analytical machine learning models—e.g., the analytical machine learning model 108. In some embodiments, the analytical machine learning model 108 may be trained to analyze real data that may include one or more characteristics corresponding to synthetic data included in the synthetic dataset 106.

The analytical machine learning model 108 may include any suitable algorithms, computer systems, neural networks, deep learning models, and/or other models that may be configured to analyze one or more characteristics corresponding to input data. By way of example and not limitation, the analytical machine learning model 108 may include: a supervised model, an unsupervised model, a semi-supervised model, artificial neural networks, and/or other machine learning models, systems, and/or neural networks. In some embodiments of the present disclosure, the analytical machine learning model 108 may be configured to analyze one or more characteristics corresponding to real input data based on being trained using the synthetic dataset 106.

In some embodiments, real input data, as used in this disclosure, may refer to data measured, collected, and/or generated in a real-world environment that may include one or more characteristics included in the real data included in the sensitive dataset 102 that may be used to train the generative machine learning model 104. In some embodiments, the real input data may not include the real data used to train the generative machine learning model 104.

For example, the analytical machine learning model 108 may include one or more algorithms, systems, and/or models that may receive and/or otherwise obtain synthetic data including one or more characteristics. Continuing the example, the analytical machine learning model 108, after being trained using the synthetic data included in the synthetic dataset 106, may be configured to identify corresponding characteristics in real input data. In these and other embodiments, using the analytical machine learning model 108 to analyze real input data may be described and illustrated further in the present disclosure, such as, for example, with respect to FIG. 1B.

By way of example and not limitation, in the context of MRI data corresponding to an anterior cruciate ligament (ACL) tear, the generative machine learning model 104 may generate synthetic data using the MRI data; the MRI data may include images of healthy ACLs, partially torn ACLs, fully torn ACLs, etc. Continuing the example, the synthetic data generated using the generative machine learning model 104 may include one or more characteristics included in the medical imaging data (e.g., new images including healthy ACLs, partially torn ACLs, fully torn ACLs etc.). Further, the synthetic data may not be traceable back to the MRI data and/or any corresponding metadata designated for protection (e.g., patient information, time, date, location, etc.) thereby rendering the synthetic data not designated for protection. Continuing the example, the synthetic data may be used to train the analytical machine learning model 108 to recognize one or more characteristics of an ACL tear (e.g., a healthy ACL, partially torn ACL, fully torn ACL, etc.) in one or more datasets including real input data.

By way of another example and not limitation, in the context of data corresponding to echocardiograms, the generative machine learning model 104 may generate synthetic data using echocardiogram data; the echocardiogram data may include sound waves, tabular data, etc. Continuing the example, the synthetic data generated and/or augmented using the generative machine learning model 104 may include one or more characteristics included in the electrocardiogram data (e.g., new and/or augmented sound waves corresponding to one or more structures of one or more hearts and/or tabular data corresponding to one or more electrocardiogram tests). Further, the synthetic data may not be traceable back to the echocardiogram and/or any corresponding metadata designated for protection (e.g., patient information, time, date, location, etc.) thereby rendering the synthetic data not designated for protection. Continuing the example, the synthetic data may be used to train the analytical machine learning model 108 to recognize and/or analyze one or more characteristics of a heart (e.g., a healthy heart structure, unhealthy heart structure, good blood flow, poor blood flow, etc.) in one or more datasets including real input data.

FIG. 1B illustrates an example environment 150 for using the analytical machine learning model 108 of FIG. 1A as trained to analyze and/or recognize one or more characteristics in real input data 110, in accordance with one or more embodiments of the present disclosure. In some embodiments, the environment 150 may be analogous to or the same as the environment 100 described in the present disclosure, such as, for example, with respect to FIG. 1A.

Real input data 110 as used in this disclosure, may refer to data measured, collected, and/or generated in a real-world environment. In some embodiments, the real input data 110 may include one or more different amounts of data and/or datasets that may be analyzed by the analytical machine learning model 108. In some embodiments, real input data 110A may include a first amount of real input data 110, real input data 110B may include a second amount of real input data 110, up to and including real input data 110n that may include an nth amount of real input data 110.

In some embodiments, the real input data 110 may include one or more characteristics included in sensitive data that may be used to train one or more generative machine learning models—e.g., sensitive data corresponding to the sensitive dataset 102 and/or the generative machine learning model 104 described and illustrated further in the present disclosure, such as, for example, with respect to FIG. 1A.

In some embodiments, the real input data 110 may include one or more similarities, features, properties, and/or characteristics that may be included in the data used to train the analytical machine learning model 108—e.g., the synthetic dataset 106 used to train the analytical machine learning model 108.

For example, the analytical machine learning model 108 may have been trained using synthetic data that may include one or more characteristics included in MRI images of one or more types of knee injuries. Continuing the example, the analytical machine learning model 108 may analyze real input data 110 that may include MRI images of different knee injuries and, based on the training data, the analytical machine learning model 108 may be configured to analyze, diagnose, or otherwise identify the one or more knee injuries presented in the real input data 110. In contrast, continuing the example, real input data 110 including medical images of other injuries (e.g., brain images, heart images, etc.) may not be accurately analyzed by the analytical machine learning model 108 based on the characteristics in the synthetic data used to train the analytical machine learning model 108.

In these and other embodiments, the analytical machine learning model 108 may be the same as and/or analogous to the analytical machine learning model 108 and/or the analytical machine learning model 214 described and illustrated further in the present disclosure, such as, for example, with respect to FIGS. 1A and 2B.

In some embodiments, the analytical machine learning model 108 may be configured to generate output data 114 that may correspond to the real input data 110. For example, in some embodiments, the output data 114 may include data and/or information that may describe one or more characteristics associated with the real input data 110. Additionally or alternatively, the output data 114 may include data and/or information included in the real input data 110. Additionally or alternatively, the output data 114 may include data and/or information associated with one or more determinations, inferences, conclusions, diagnoses, recommendations, etc. that may correspond to the real input data 110. In some embodiments, output data 114A may correspond to real input data 110A, output data 114B may correspond to real input data 110B, up to and including output data 114n that may correspond to real input data 110n.

The output data 114 may include data and/or information that may correspond to analysis of the real input data 110 by the analytical machine learning model 108. In some embodiments, the output data 114 may include one or more characteristics corresponding to the real input data 110. For example, in the context of using written or typed data, the analytical machine learning model 108 may be trained to analyze real input data 110 that may include medical notes corresponding to a patient. Continuing the example, the output data 114 generated using the analytical machine learning model 108 may include the words included in the medical notes, important categories of information in the medical notes (e.g., patient health information, doctor's potential diagnoses, abnormalities in the notes, etc.), etc.

In some embodiments, the output data 114 may include one or more determinations generated using the analytical machine learning model 108. For example, continuing in the context of the real input data 110 including medical notes of the patient, the analytical machine learning model 108 may be configured to determine one or more diagnoses, inferences, conclusions, and/or other determinations based on the medical notes corresponding to the patient. Continuing the example, the medical notes may include dietary habits, blood pressure readings, weight, height, family medical history, etc. corresponding to the patient. Further, the output data 114 may include a determination that the patient may have high blood pressure, recommendations including dietary changes, recommendations for one or more blood pressure medications, etc.

As an additional example, the analytical machine learning model 108 may be trained to analyze medical images (e.g., MRI, x-ray, etc.) corresponding to knees, including knee injuries. Continuing the example, the analytical machine learning model 108 may have been trained using synthetic data corresponding to a synthetic dataset (e.g., synthetic dataset 106) generated using one or more generative machine learning models (e.g., generative machine learning model 104). The one or more generative machine learning models may have been trained to generate synthetic data including medical images of one or more knees based on sensitive data (e.g., sensitive data corresponding to the sensitive dataset 102) from one or more data sources. Further, the analytical machine learning model 108 may be configured to collect information using the real input data 110 (e.g., one or more medical images of different knees) and to analyze the real input data 110 to generate output data 114. Further continuing the example, the output data 114 may include data and/or information corresponding to the real input data 110—e.g., identifying anatomical features of the knee, identifying one or more abnormalities associated with the image, etc. Additionally or alternatively, the analytical machine learning model 108 may be configured to include one or more determinations in the output data 114—e.g., diagnosing a torn ligament, broken kneecap, inflammation, etc. The analytical machine learning model 108 may additionally be configured to generate one or more recommendations that may be included in the output data 114—e.g., medications to help reduce inflammation, recommending various procedures to remedy abnormalities, etc.

Modifications, additions, or omissions may be made to FIG. 1A and/or FIG. 1B without departing from the scope of the present disclosure. For example, the amount of sensitive data used and/or synthetic data generated may vary. Further, the number and/or types of generative machine learning models and/or analytical machine learning models may vary.

FIG. 2A illustrates an example environment 200 for training one or more generative machine learning models 206 using one or more sensitive datasets 204 corresponding to one or more data sources 202 and generating a synthetic dataset 208 using the one or more generative machine learning models 206, in accordance with one or more embodiments of the present disclosure.

The one or more data sources 202 may include databases, hard drives, storage devices, and/or other integrated systems that may be configured to aggregate, organize, and/or otherwise store the one or more sensitive datasets 204. In some embodiments, the one or more data sources 202 may correspond to one or more of the sensitive datasets 204. For example, in some embodiments, a first data source 202A may generate, aggregate, and/or otherwise store a first sensitive dataset 204A, a second data source 202B may generate, aggregate, and/or otherwise store a second sensitive dataset 204B, up to and including an nth data source 202n that may generate, aggregate, and/or otherwise store an nth sensitive dataset 204n.

In some embodiments, the one or more sensitive datasets 204 may include sensitive data that may include one or more labels. In some embodiments, the sensitive data may be labeled such that the sensitive data may be used to train one or more machine learning models and/or systems (e.g., the one or more generative machine learning models 206). In some embodiments, labeled sensitive data may refer to sensitive data that may be marked up, annotated, tagged, classified, processed, and/or otherwise labeled such that one or more machine learning models may be trained using the data.

For example, in the context of medical data used as the sensitive data included in one or more sensitive datasets 204, the sensitive data may include one or more brain scans or images. Further, some of the images may include one or more abnormalities (e.g., bleeding, tumors, inflammation, etc.). One or more of the images may then be labeled to include annotations that may indicate when an image may show a healthy brain, a brain with abnormal bleeding, a brain with inflammation, a brain with a tumor, etc. Continuing the example, the one or more machine learning models may be trained, for example, to generate one or more images including healthy brains, brains with inflammation, brains with tumors, etc.

In some embodiments, using well-labeled sensitive data to train the one or more generative machine learning models 206 may improve performance of the one or more generative machine learning models 206. In these and other embodiments, identifying whether the one or more generative machine learning models 206 may have been trained using well-labeled sensitive datasets 204 may be described and illustrated further in the present disclosure, such as, for example, described with respect to the filtering module 210 in FIG. 2B.

In some embodiments, one or more entities may own and/or otherwise control the one or more data sources 202 and the one or more corresponding sensitive datasets 204. In some embodiments, a first entity may own and/or control the first data source 202A and the first sensitive dataset 204A, a second entity may own and/or control the second data source 202B and the second sensitive dataset 204B, and an nth entity may own and/or control the nth data source 202n and the nth sensitive dataset 204/1.

In some embodiments, the data sources 202 and the corresponding sensitive datasets 204 may be kept separate because the data, or a portion of the data, included in the sensitive datasets 204 may be designated for protection. For example, in the context of the sensitive datasets 204 including medical data, the first entity may include a hospital where the first sensitive dataset 204A corresponding to the first data source 202A may include personal identifying information and therefore may be prohibited from being shared by law, at least without the consent of every patient whose data may be included in the first sensitive dataset 204A. Further, the second entity may include an insurance company where the second sensitive dataset 204B corresponding to the second data source 202B may include medical data including personal identifying information and therefore may be prohibited from being shared by law, at least without the consent of the insured whose data may be included in the second sensitive dataset 204B. Because the sensitive datasets 204 may not be easily shared and/or prohibited by law from being shared between the hospital and the insurance company, the first sensitive dataset 204A may correspond to the first data source 202A and remain separate from the second sensitive dataset 204B that may correspond to the second data source 202B.

The one or more generative machine learning models 206 may include one or more algorithms, machine learning models, systems including machine learning models, etc. that may be trained using one or more sensitive datasets (e.g., sensitive datasets 204). In some embodiments, the one or more generative machine learning models 206 may be configured to generate synthetic data corresponding to one or more synthetic datasets 208 based at least on being trained using the one or more sensitive datasets 204. In some embodiments, a first generative machine learning model 206A may be trained using data corresponding to the first sensitive dataset 204A, a second generative machine learning model 206B may be trained using data corresponding to the second sensitive dataset 204B, up to and including an nth generative machine learning model 206n that may be trained using data corresponding to the nth sensitive dataset 204n. In these and other embodiments, the one or more generative machine learning models 206 may be the same as and/or analogous to other generative machine learning models described and illustrated in the present disclosure, such as, for example, generative machine learning model 104 described and illustrated with respect to FIG. 1A.

In some embodiments, the one or more generative machine learning models 206 may be trained using one or more sensitive datasets 204. In some embodiments, the first sensitive dataset 204A, the second sensitive dataset 204B, up to and including the nth sensitive dataset 204n may be used to train the one or more generative machine learning models 206.

In some embodiments, the first generative machine learning model 206A may include a different type of generative machine learning model 206 than the second generative machine learning model 206B—e.g., the first generative machine learning model 206A may include a GAN and the second generative machine learning model 206B may include a VAE. In some embodiments, the first generative machine learning model 206A and the second generative machine learning model 206B may include the same type of generative machine learning model 206 (e.g., both may include a GAN). In some embodiments, the first generative machine learning model 206A and the second generative machine learning model 206B may be the same machine learning model 206.

In some embodiments, the one or more generative machine learning models 206 may generate synthetic data based at least on the sensitive data included in the one or more sensitive datasets 204 used to train the multiple machine learning models 206. In some embodiments, continuing in the context of a first generative machine learning model 206A, a second generative machine learning model 206B, and an nth generative machine learning model 206, the first generative machine learning model 206A may be trained using a first sensitive dataset 204A and may, based on being trained using the first sensitive dataset 204A, generate a first amount of synthetic data. The second generative machine learning model 206B may be trained using a second sensitive dataset 204B and may, based on being trained using the second sensitive dataset 204B, generate a second amount of synthetic data. The nth generative machine learning model 206n may be trained using an nth sensitive dataset 204n and may, based on being trained using the nth sensitive dataset 204n, generate an nth amount of synthetic data. Continuing the example, the first amount of synthetic data, the second amount of synthetic data, and the nth amount of synthetic data may be included in the synthetic dataset 208.

In some embodiments, the first generative machine learning model 206A may be trained using data corresponding to one or more of the sensitive datasets 204. In some embodiments, the first generative machine learning model 206A may be trained using the first sensitive dataset 204A, the second sensitive dataset 204B, up to and including the nth sensitive dataset 204/1.

In some embodiments, because the sensitive data included in the sensitive datasets 204 may not be easily shared, the one or more generative machine learning models 206 may be trained by one or more entities, systems, users, etc. without sharing sensitive data included in the sensitive datasets 204. For example, the first entity may train the first generative machine learning model 206A using sensitive data corresponding to the first sensitive dataset 204A, the second entity may additionally train the second generative machine learning model 206B using sensitive data corresponding to the second sensitive dataset 204B, up to and including an nth entity that may train the nth generative machine learning model 206 using sensitive data corresponding to the nth sensitive dataset 204/1.

In some embodiments, one of the one or more generative machine learning models 206 may be trained by one or more entities that may own and/or control the one or more respective data sources 202. For example, the first entity may train the first generative machine learning model 206A using sensitive data corresponding to the first sensitive dataset 204A. Further the second entity may train the first generative machine learning model 206A using sensitive data corresponding to the second sensitive dataset 204B, up to and including the nth entity may train the nth generative machine learning model 206n using sensitive data corresponding to the nth sensitive dataset 204/1.

In some embodiments, the one or more generative machine learning models 206 may be configured to generate synthetic data that may be included in the synthetic dataset 208. In some embodiments, the synthetic dataset 208 may include synthetic data that may include one or more traits, characteristics, properties, data, etc. that may have been included in the sensitive data included in the one or more sensitive datasets 204. In these and/or other embodiments, the synthetic dataset 208 may include, may be the same as, and/or may be analogous to synthetic data and/or synthetic datasets described and illustrated further in the present disclosure, such as, for example the synthetic dataset 106 described and illustrated with respect to FIG. 1.

By way of example and not limitation, a first entity and second entity may each include a pharmaceutical or biosciences company that may be in the business of discovering useful molecular structures, pharmaceuticals, and the like. The first entity may own and/or control a first data source 202A that may include a first sensitive dataset 204A including data and/or information corresponding to intellectual property of the first entity (e.g., particular properties, molecular structures, properties of pharmaceuticals, etc.). The second entity may own and/or control a second data source 202B that may include a second sensitive dataset 204B that may include data and/or information corresponding to intellectual property of the second entity (e.g., particular properties, molecular structures, properties of pharmaceuticals, etc.). Neither the first entity nor the second entity may be willing and/or able to share the sensitive data and/or information corresponding to intellectual property corresponding to either entity. Because data and/or information may not be easily shared, the first entity may train the first generative machine learning model 206A using sensitive data corresponding to the first sensitive dataset 204A and the second entity may additionally train the second generative machine learning model 206B using sensitive data corresponding to the second sensitive dataset 204B.

Continuing the example, the first generative machine learning model 206A may generate a first amount of synthetic data and the second generative machine learning model 206B may generate a second amount of synthetic data. Further, the first amount of synthetic data and the second amount of synthetic data may be included in the synthetic dataset 208. The synthetic dataset 208 that may not include any of the intellectual property of either the first entity or the second entity. However, the synthetic dataset 208 may be used by the first entity, the second entity, and/or others as a training dataset for one or more other machine learning models—e.g., analytical machine learning models that may be configured to further analyze other data that may be associated with molecular structures, pharmaceutical properties, etc.

In some embodiments, the synthetic dataset 208 may include synthetic data that may be used to train one or more other machine learning models that may be described and/or illustrated further in the present disclosure, such as, for example, the analytical machine learning model 108, the analytical machine learning model 214 described with respect to FIGS. 1A, 1B, and 2B.

FIG. 2B illustrates an example environment 250 for training an analytical machine learning model 214 based on the synthetic dataset 208 of FIG. 2A, in accordance with one or more embodiments of the present disclosure. In these or other embodiments, the example environment 250 may be the same as and/or an extension of the environment 200 described and illustrated further in the present disclosure, such as, for example, with respect to FIG. 2A.

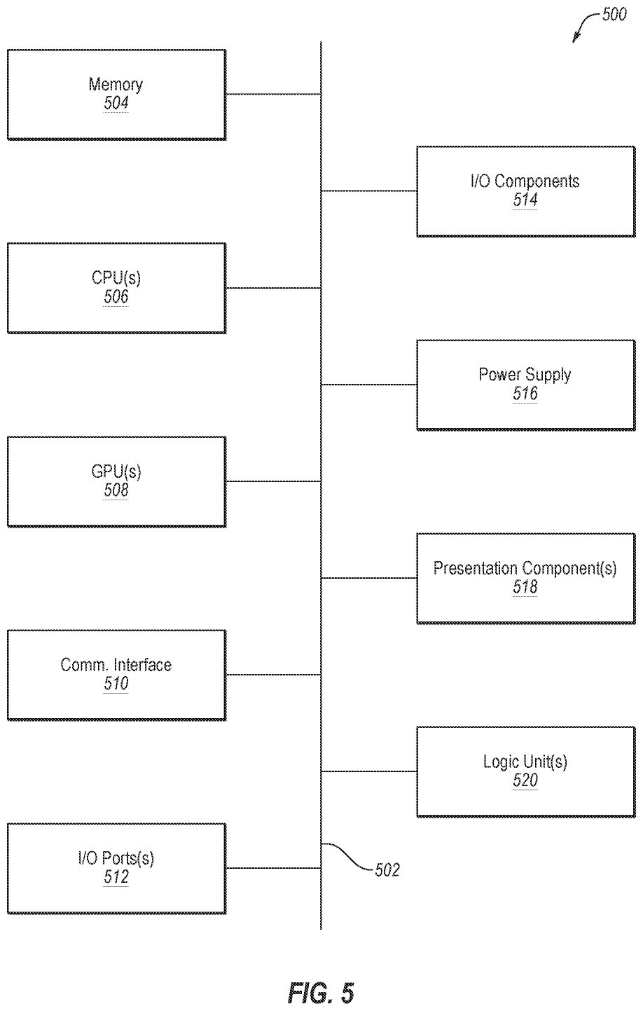

In some embodiments, the environment 250 may include a filtering module 210. In these or other embodiments, the one or more modules corresponding to the error handling system 102 may be implemented using hardware including one or more processors, central processing units (CPUs) graphics processing units (GPUS), data processing units (DPUs), parallel processing units (PPUs), microprocessors (e.g., to perform or control performance of one or more operations), programmable vision accelerators (PVAs)—which may include one or more direct memory access (DMA) systems and/or one or more vector or vision processing units (VPUs), field-programmable gate arrays (FPGA), application-specific integrated circuits (ASICs), accelerators (e.g., deep learning accelerators (DLAs)), and/or other processor types. In some other instances, one or more of these modules may be implemented using a combination of hardware and software. In the present disclosure, operations described as being performed by the filtering module 210 may include operations that the filtering module 210 may direct a corresponding computing system to perform. In these or other embodiments, the filtering module 210 may be implemented by one or more computing devices, such as that described in further detail with respect to FIGS. 4A-4D, 5, and/or 6.

The filtering module 210 may be configured to perform one or more operations that may take away synthetic data, add synthetic data, and/or modify existing synthetic data included in the synthetic dataset 208. Further, the filtering module 210 may be configured to perform one or more operations that may modify the synthetic dataset 208 in such a way that may result in a filtered synthetic dataset 212. For example, the filtering module 210 may take away a portion of synthetic data included in the synthetic dataset 208, the remaining synthetic data together may be designated as the filtered synthetic dataset 212.

In some embodiments, the filtering module 210 may be configured to determine whether the synthetic data generated using the generative machine learning model 206 may be similar to the sensitive data used to train the generative machine learning model 206. By way of example and not limitation, in instances in which the sensitive data included in the first sensitive dataset 204A is well-labeled and includes enough data, the generative machine learning model 206 may be trained to generate synthetic data that may be similar to the sensitive data included in the first sensitive dataset 204A.

In some embodiments, “similar” as used in this context may mean that one or more of the variables in the sensitive dataset 204 may be present in the synthetic dataset 208, the frequency of the variables present in the sensitive dataset 204 may be present in the synthetic dataset 208, correlations between variables in the sensitive dataset 204 may also be present in the synthetic dataset 208, etc. In some embodiments, the filtering module 210 may be configured to determine whether the synthetic data is similar to the sensitive data used to train the generative machine learning model 206. Additionally or alternatively, in response to the sensitive data and the synthetic data being sufficiently different (e.g., not satisfying a similarity threshold), the filtering module 210 may be configured to filter synthetic data deemed as being sufficiently different out of the synthetic dataset 208.

In some embodiments, the filtering module 210 may be configured to determine whether the generative machine learning model 206 may have been trained using well-labeled real data (e.g., real data included in the one or more sensitive datasets 204) by evaluating one or more characteristics of the generated synthetic data against one or more quality considerations—e.g., randomness of the synthetic data, how closely the synthetic data resembles real data, similarity with training data, etc. In some embodiments, the evaluating the synthetic data may result in one or more values identifying the quality of the labeled synthetic data included in the synthetic dataset 208 and, correspondingly, the quality of the sensitive data used to train the generative machine learning model—e.g., identifying how well-labeled the synthetic data may be.

In some embodiments, the quality of the synthetic data included in the synthetic dataset 208 may be assessed based on whether information included in the real data (e.g., data included in the one or more sensitive datasets 204) is also present in the synthetic data include in the synthetic dataset 208. In some embodiments, the filtering module 210 may be configured to determine whether one or more variables, labels, and/or categories of information present in the sensitive data included in the sensitive datasets 204 are also present in synthetic data included in the synthetic dataset 208. For example, distributions of the one or more variables, labels, and/or categories may be assessed in both the sensitive datasets 204 and the synthetic dataset 208 to determine whether the desired variables are present. If not, or if the distributions are different beyond a predetermined threshold, it may be determined that the one or more sensitive datasets 204 used to train the generative machine learning model 206 may not have been well-labeled and that data may be filtered out of the synthetic dataset 208 using the filtering module 210.

In some embodiments, the filtering module 210 may be configured to perform one or more statistical correlation analyses where the statistical correlation analyses may determine a correlation between variables in the one or more sensitive datasets 204 and compare that correlation to a correlation between variables in the synthetic dataset 208. In some embodiments, if the correlation between variables in the sensitive dataset is different from the correlation between variables by a predetermined amount, it may be determined that the sensitive data included in the sensitive dataset 204 may not have been well-labeled and the filtering module 210 may be configured to remove the corresponding data from the synthetic dataset 208.

In some embodiments, the filtering module 210 may be configured to analyze a combination of variables and frequency of the variables in the one or more sensitive datasets 204 and in the synthetic data generated therefrom. In some embodiments, if the difference between the combination of variables and frequency of the variables is above a predetermined threshold, it may be determined that the sensitive data may not have been well-labeled and the filtering module 210 may be configured to remove the corresponding data from the synthetic dataset 208.

Other examples of determining whether the sensitive data may be well-labeled based on the synthetic data may include an inception score, Frechet Inception Distance (FID) score, and other values that may identify the quality of the synthetic data generated using the generative machine learning model 206. In some embodiments, if one or more of the values identifying the quality of the synthetic data is not within a predetermined threshold, the synthetic data may be removed from the synthetic dataset 208 and may not be included in the filtered synthetic dataset 212.

In some embodiments, the filtered synthetic dataset 212 may include synthetic data that may have been generated using one or more generative machine learning models 206 using one or more sensitive datasets 204. In some embodiments, the filtered synthetic dataset 212 may include, be the same as, and/or analogous to synthetic datasets described and illustrated further in the present disclosure, such as, for example, with respect to FIGS. 1A and 2A.

In some embodiments, the filtered synthetic dataset 212 may be used to train the analytical machine learning model 214 to analyze one or more characteristics included in real input data. In these and other embodiments, the analytical machine learning model 214 may be the same as and/or analogous to other analytical machine learning models described and illustrated in the present disclosure, such as, for example, the analytical machine learning model 108 described with respect to FIGS. 1A and 1B.

In some embodiments, the analytical machine learning model 214 may be trained using the filtered synthetic dataset 212. In some embodiments, the filtered synthetic dataset 212 may include only synthetic training data generated by the generative machine learning model 206 in instances in which the generative machine learning model 206 may have been trained by well-labeled real data. In these and other embodiments, the analytical machine learning model 214 trained using the filtered synthetic dataset 212 may be faster, more efficient, and/or more accurate at recognizing one or more characteristics in real input data than an analytical machine learning model that may not have been trained using the filtered synthetic dataset 212.

Modifications, additions, or omissions may be made to FIG. 2A and/or FIG. 2B without departing from the scope of the present disclosure. For example, the number of data sources 202 and corresponding sensitive datasets that may be used to train one or more generative machine learning models 206 may vary. Further, in some embodiments, the filtering module 210 and its corresponding operations may be omitted.

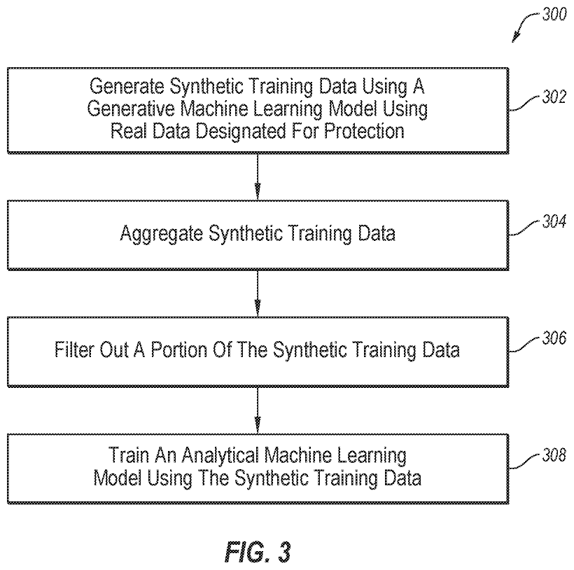

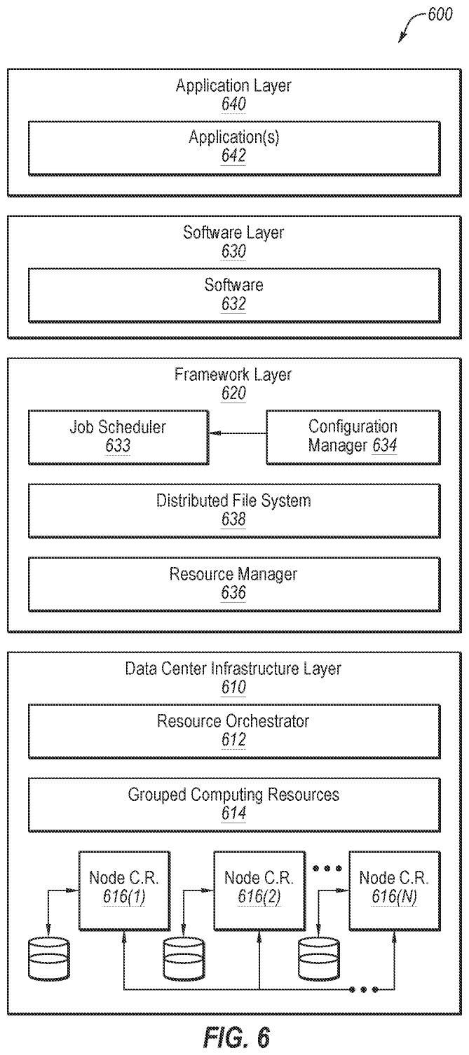

FIG. 3 is a flow diagram showing a method 300 for training an analytical machine learning model using synthetic data that is used as a substitute for sensitive data, in accordance with one or more embodiments of the present disclosure. One or more operations of the method 300 may be performed by any suitable system, apparatus, or device such as, for example the generative machine learning model 104, the analytical machine learning model 108 of FIG. 1, the generative machine learning model 206, the filtering module 210, the analytical machine learning module 214 of FIG. 2, the autonomous vehicle system(s) described with respect to FIGS. 4A-4D, computing device(s) described with respect to FIG. 5, and/or the data system(s) described with respect to FIG. 6 in the present disclosure.

The method 300 may include one or more blocks 302, 304, 306, and 308. Although illustrated with discrete blocks, the operations associated with one or more of the blocks of the method 300 may be divided into additional blocks, combined into fewer blocks, or eliminated, depending on the particular implementation.

In some embodiments, the method 300 may include block 302. At block 302, synthetic training data may be generated using one or more generative machine learning models. In some embodiments, the one or more generative machine learning models may be trained using real data that may be designated for protection referred to also herein as “real training data.” In some embodiments, the real training data may include sensitive data described and illustrated in the present disclosure, such as, for example, with respect to FIGS. 1A and 2A. In some embodiments, the real training data may be collected and measured in the real-world whereas synthetic data may be generated by one or more generative machine learning models instead of being collected and measured in the real-world. In some embodiments, real training data may include at least one of medical data, personal data, sensor data, secrets, intellectual property, sensor data, video streams, client specific data, other data that may be designated for protection. The data designated for protection may also be referred to herein as data corresponding to one or more protected data sources. In some embodiments, the synthetic data generated using the one or more machine learning models may include one or more characteristics, attributes, traits, labels, etc. that may be included in the real training data. In some embodiments, the synthetic data may be generated using one or more generative machine learning models that may perform one or more operations on real training data corresponding to one or more data sources. In these and other embodiments, one or more generative machine learning models may generate synthetic data based on being trained using real training data as described and illustrated further in the present disclosure, such as, for example, with respect to FIGS. 1A and 2A.

At block 304, the synthetic training data may be aggregated. In these and other embodiments, the synthetic data that may be generated using one or more generative machine learning models may be aggregated in a synthetic dataset. For example, a first generative machine learning model may generate a first amount of synthetic data based on being trained using a first sensitive dataset that may include real training data designated for protection. Continuing the example, a second generative machine learning model may generate a second amount of synthetic data based on being trained using a second sensitive dataset that may include real training data designated for protection. Further, the first amount of synthetic data and the second amount of synthetic data may be aggregated and/or combined to be included in a synthetic dataset. In some embodiments, the synthetic data included in the synthetic dataset may be used to train an analytical machine learning model. In these and other embodiments, aggregating synthetic data may be described and/or illustrated further in the present disclosure, such as, for example, with respect to FIGS. 1A and 2A

At block 306, an amount of synthetic training data may be filtered out of the synthetic dataset. In some embodiments, the synthetic training data may be filtered based at least on a determination as to whether the real training data used to train the one or more generative machine learning models is properly labeled and/or annotated. In some embodiments, the determination as to whether real training data is properly labeled may be made by evaluating one or more characteristics of the generated synthetic data against one or more quality considerations. For example, quality considerations may include randomness of the synthetic data, how closely the synthetic data resembles real training data, similarity of the synthetic data with training data, etc. In some embodiments, synthetic training data may be filtered out based on whether a first distribution corresponding to the synthetic training data is different by more than a threshold compared to a second distribution corresponding to the real training data. In some embodiments, the threshold may be determined using one or more heuristic analyses. In these and other embodiments, filtering out an amount of synthetic data from the synthetic dataset may be described and illustrated further in the present disclosure, such as, for example, with respect to FIG. 2B.

At block 308, an analytical machine learning model may be trained. In some embodiments, the analytical machine learning model may be trained using the synthetic training data that may be generated using one or more generative machine learning models. In some embodiments, the analytical machine learning model may be trained to analyze one or more characteristics corresponding to real input data. In some embodiments, the real input data may include one or more similar characteristics, traits, features, etc. that may be included and/or present in the real training data designated for protection used to train the one or more generative machine learning models. In these and other embodiments, training the analytical machine learning model using synthetic data generated using the generative machine learning model may be described and illustrated further in the present disclosure, such as, for example, with respect to FIGS. 1B and 2B.

Modifications, additions, or omissions may be made to one or more operations included in the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more CPU(s), system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, and/or to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) 446 (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the HD map 422 of FIG. 4C), location data (e.g., the location of the vehicle 400, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424, which may use one or more wireless antenna(s) 426 and/or modem(s) to communicate over one or more networks. For example, the network interface 424 may be capable of communication over LTE, WCDMA, UMTS, GSM, CDMA2000, etc. The wireless antenna(s) 426 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward-facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may any number of wide-view cameras 470 on the vehicle 400. In addition, long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

One or more stereo cameras 468 may also be included in a front-facing configuration. The stereo camera(s) 468 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360-degree camera(s), and/or the like. For example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround-view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C is illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400 and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting, and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected to both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s)(ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe-stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always-on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428, which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPD (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data, in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surrounding at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 100 m, with an accuracy of 2 cm-3 cm, and with support for a 100 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 200 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 400), while the 12V communication concept provides information about traffic further ahead. CACC systems may include either or both I2V and V2V information sources. Given the information of the vehicles ahead of the vehicle 400, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network that is trained and thus reduces the risk of false positives, as described herein.

The vehicle 400 may further include the infotainment SoC 430 (e.g., an in-vehicle infotainment system (IVI)). Although illustrated and described as an SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 400. For example, the infotainment SoC 430 may include radios, disk players, navigation systems, video players, USB and Bluetooth connectivity, carputers, in-car entertainment, Wi-Fi, steering wheel audio controls, hands-free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe-stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, include wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 632, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 600. In at least one embodiment, trained or deployed machine learning models corresponding to one or more neural networks may be used to infer or predict information using resources described in the present disclosure with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
performing one or more operations using a machine learning model, the machine learning model being trained, at least in part, using synthetic training data generated using one or more generative machine learning models, the one or more generative machine learning models being trained to generate the synthetic training data based at least on real training data designated for protection.

2. The method of claim 1, wherein the real training data corresponds to one or more protected data sources.

3. The method of claim 2, wherein:
the one or more protected data sources includes one or more medical data repositories;
the real training data includes labeled medical imaging data; and
the synthetic training data includes data generated using the one or more generative machine learning models and based at least on the labeled medical imaging data.

4. The method of claim 1, wherein a portion of the synthetic training data is filtered out based at least on a determination that a first distribution corresponding to the synthetic training data is different by more than a threshold compared to a second distribution corresponding to the real training data.

5. The method of claim 1, wherein the one or more generative machine learning models are trained using the real training data local to a first location that stores the real training data, and the machine learning model is trained at a second location different from the first location.

6. The method of claim 1, wherein the one or more generative machine learning models learn one or more first distributions associated with the real training data such that one or more second distributions associated with the synthetic training data are within a threshold similarity to the one or more first distributions.

7. A system comprising:
one or more processing units to perform operations comprising:
performing one or more operations using a machine learning model, the machine learning model being trained, at least in part, using synthetic training data generated using one or more generative machine learning models, the one or more generative machine learning models being trained to generate the synthetic training data based at least on real training data designated for protection.

8. The system of claim 7, wherein real training data corresponds to one or more protected data sources.

9. The system of claim 8, wherein:
the one or more protected data sources includes one or more medical data repositories;
the real training data includes labeled medical imaging data; and
the synthetic training data includes data generated using the one or more generative machine learning models and based at least on the labeled medical imaging data.

10. The system of claim 7, wherein a portion of the synthetic training data is filtered out based at least on a determination that a first distribution corresponding to the synthetic training data is different by more than a threshold compared to a second distribution corresponding to the real training data.

11. The system of claim 7, wherein the one or more generative machine learning models are trained using the real training data local to a first location that stores the real training data, and the machine learning model is trained at a second location different from the first location.

12. The system of claim 7, wherein the one or more generative machine learning models learn one or more first distributions associated with the real training data such that one or more second distributions associated with the synthetic training data are within a threshold similarity to the one or more first distributions.

13. The system of claim 7, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more language models;
a system implementing one or more large language models (LLMs);
a system for generating synthetic data;
a system incorporating one or more virtual machines (VMs);
a system implemented at least partially in a data center; or
a system implemented at least partially using cloud computing resources.

14. A processor comprising processing circuitry to perform operations, the operations comprising:
performing one or more operations using a machine learning model, the machine learning model being trained, at least in part, using synthetic training data generated using one or more generative machine learning models, the one or more generative machine learning models being trained to generate the synthetic training data based at least on real training data designated for protection.

15. The processor of claim 14, wherein the real training data corresponds to one or more protected data sources.

16. The processor of claim 15, wherein:
the one or more protected data sources includes one or more medical data repositories;
the real training data includes labeled medical imaging data; and
the synthetic training data includes data generated using the one or more generative machine learning models and based at least on the labeled medical imaging data.

17. The processor of claim 14, wherein a portion of the synthetic training data is filtered out based at least on a determination that a first distribution corresponding to the synthetic training data is different by more than a threshold compared to a second distribution corresponding to the real training data.

18. The processor of claim 14, wherein the one or more generative machine learning models are trained using the real training data local to a first location that stores the real training data, and the machine learning model is trained at a second location different from the first location.

19. The processor of claim 14, wherein the one or more generative machine learning models learn one or more first distributions associated with the real training data such that one or more second distributions associated with the synthetic training data are within a threshold similarity to the one or more first distributions.

20. The processor of claim 14, wherein the operations are performed by a system and wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more language models;
a system implementing one or more large language models (LLMs);
a system for generating synthetic data;
a system incorporating one or more virtual machines (VMs);
a system implemented at least partially in a data center; or
a system implemented at least partially using cloud computing resources.
